(19) United States
(12) Patent Application Publication
(10) Pub. No.: US 2010/0140137 A1
(43) Pub. Date: Jun. 10, 2010

(54) FUEL CONVERSION SYSTEM, APPARATUS, AND METHOD

(76) Inventors: Gregg A. Deluga, Playa del Rey, CA (US); Dan Hancu, Clifton Park, NY (US); Jin Ki Hong, Cypress, CA (US); Daniel G. Norton, Niskayuna, NY (US); Rick B. Watson, Missouri City, TX (US); Arturo Vazquez, Santa Fe Springs, CA (US); Ramanathan Subramanian, Orange, CA (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(21) Appl. No.: 12/331,622

(22) Filed: Dec. 10, 2008

(51) Int. Cl. C10G 11/00; B01J 21/04; B01J 23/60; B01J 23/46; B01J 23/42; B01J 23/656; B01J 23/63; B01J 19/00

(52) U.S. Cl. 208/113; 502/355; 502/325; 502/304; 502/339; 502/329; 502/303; 422/211; 422/177

(57) ABSTRACT

A reductant producing apparatus and method is provided, the apparatus includes a catalyst attached to an encasement. The encasement has a first and second intake formed therein that are fluidly coupled to the catalyst. The first intake configured to allow entry of a hydrocarbon fuel into the encasement. The second intake is configured to allow entry of oxygen into the encasement. The catalyst is configured to catalyze an autothermal reaction to convert a mixture into a plurality of reductants comprising a plurality of hydrocarbons having a hydrocarbon chain length that is less than a hydrocarbon chain length of hydrocarbons in the hydrocarbon fuel. The mixture comprises the hydrocarbon fuel and the oxygen, and the mixture has a carbon-to-oxygen ratio that is greater than a one-to-one ratio.

### BACKGROUND

1. Technical Field

The invention includes embodiments that relate to reductant production. Embodiments of the invention relate to vehicles, locomotives, generators, and the like. Embodiments of the invention relate to a method of manufacturing a catalyst that aids in the production of reductants during NOₓ reductions.

2. Discussion of Art

Production of emissions from mobile and stationary combustion sources such as locomotives, vehicles, power plants, and the like, contribute to environmental pollution. One particular source of such emissions are nitric oxides (NOₓ), such as NO or NO₂, emissions from vehicles, locomotives, generators, and the like. Environmental legislation restricts the amount of NOₓ that can be emitted by vehicles. In order to comply with this legislation, efforts have been directed at reducing the amount of NOₓ emissions.

As such, it may be desirable to have a system that has aspects and features that differ from those that are currently available. Further, it may be desirable to have a method that differs from those methods that are currently available.

### BRIEF DESCRIPTION OF THE INVENTION

The invention includes embodiments that relate to a catalyst for producing reductants to reduce NOₓ emissions. The invention includes embodiments that relate to an apparatus for producing reductants. The invention includes embodiments that relate to a method of producing a catalyst.

Aspects of the invention provide an apparatus including a catalyst attached to an encasement. The encasement has a first and second intake formed therein that are fluidly coupled to the catalyst. The first intake is configured to allow entry of a hydrocarbon fuel into the encasement. The second intake is configured to allow entry of oxygen into the encasement. The catalyst is configured to catalyze an autothermal reaction to convert a mixture into a plurality of reductants comprising a plurality of hydrocarbons having a hydrocarbon chain length that is less than a hydrocarbon chain length of hydrocarbons in the hydrocarbon fuel. The mixture comprises the hydrocarbon fuel and the oxygen, and the mixture has a carbon-to-oxygen ratio that is greater than a one-to-one ratio

Aspects of the invention also provide a method that includes forming a plurality of transport paths configured to mix a quantity of air with a quantity of hydrocarbon fuel to form a mixture and assembling a catalytic unit in fluid communication with the plurality of transport paths. The quantity of air comprises oxygen. The mixture has a carbon-to-oxygen ratio that is greater than a one-to-one ratio, and the catalytic unit is configured to catalyze an autothermal reaction that converts at least a portion of the mixture to a plurality of reductants. The plurality of reductants comprises hydrocarbon reductants having hydrocarbon chain lengths that are less than a hydrocarbon chain length of the hydrocarbon fuel.

Aspects of the invention also provide a method that includes adhering a washcoat to a catalyst support and adhering a catalyst to the washcoat. The catalyst is configured to catalyze an autothermal reaction to convert a mixture having a carbon-to-oxygen ratio greater than one-to-one into secondary hydrocarbons. The mixture comprises a hydrocarbon fuel and oxygen.

Various other features may be apparent from the following detailed description and the drawings.

### BRIEF DESCRIPTION OF THE DRAWINGS

The drawings illustrate at least one preferred embodiment presently contemplated for carrying out the invention.

In the drawings:

FIG. 1 is a schematic diagram of a fuel conversion unit for producing a plurality of reductants according to an embodiment of the invention.

FIG. 2 is a block diagram of cross-sectional view of a portion of catalytic unit according to an embodiment of the invention.

FIG. 3 is a flowchart depicting a technique for assembling a catalytic unit according to an embodiment of the invention.

### DETAILED DESCRIPTION

Embodiments of the invention provide an apparatus including a catalyst attached to an encasement. The encasement has a first and second intake formed therein that are fluidly coupled to the catalyst. The first intake is configured to allow entry of a hydrocarbon fuel into the encasement. The second intake is configured to allow entry of oxygen into the encasement. The catalyst is configured to catalyze an autothermal reaction to convert a mixture into a plurality of reductants comprising a plurality of hydrocarbons having a hydrocarbon chain length that is less than a hydrocarbon chain length of hydrocarbons in the hydrocarbon fuel. The mixture comprises the hydrocarbon fuel and the oxygen, and the mixture has a carbon-to-oxygen ratio that is greater than a one-to-one ratio.

Embodiments of the invention also provide a method that includes forming a plurality of transport paths configured to mix a quantity of air with a quantity of hydrocarbon fuel to form a mixture and assembling a catalytic unit in fluid communication with the plurality of transport paths. The quantity of air comprises oxygen. The mixture has a carbon-to-oxygen ratio that is greater than a one-to-one ratio, and the catalytic unit is configured to catalyze an autothermal reaction that converts at least a portion of the mixture to a plurality of reductants. The plurality of reductants comprises hydrocarbon reductants having hydrocarbon chain lengths that are less than a hydrocarbon chain length of the hydrocarbon fuel.

Embodiments of the invention also provide a method that includes adhering a washcoat to a catalyst support and adhering a catalyst to the washcoat. The catalyst is configured to catalyze an autothermal reaction to convert a mixture having a carbon-to-oxygen ratio greater than one-to-one into secondary hydrocarbons. The mixture comprises a hydrocarbon fuel and oxygen.

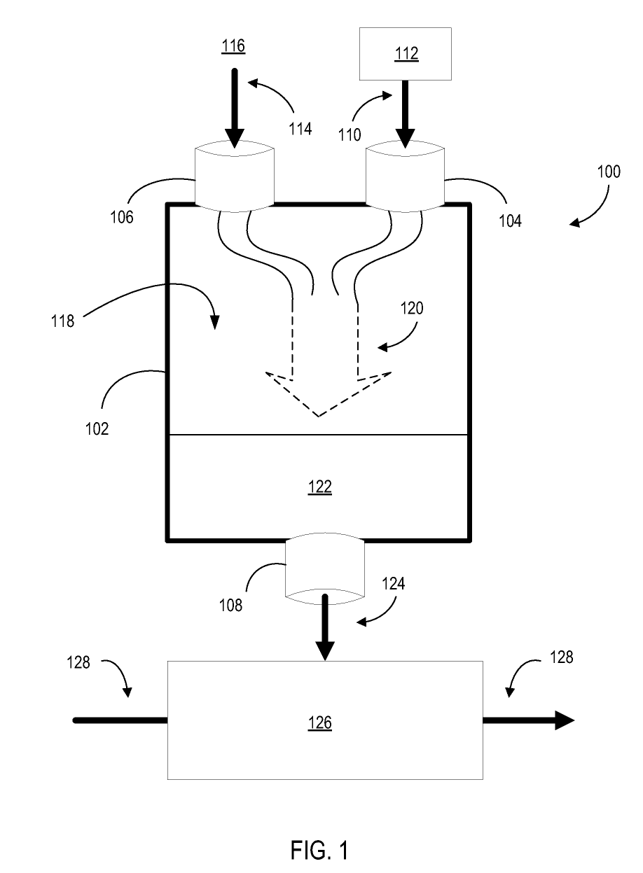

Referring to FIG. 1, a schematic diagram of a fuel conversion unit 100 for producing a plurality of reductants is shown according to an embodiment of the invention. As will be described below, the fuel conversion unit 100 produces a plurality of reductants that can be used for a selective catalytic reduction reaction to reduce NOₓ components in an exhaust stream. As shown, the fuel conversion unit 100 includes an encasement 102 having a first intake 104, a second intake 106, and an output 108. The first and second intakes 104, 106 and the output 108 are coupled to, or formed into, the encasement 102. According to an embodiment of the invention, the first intake 104 allows entry of a hydrocarbon fuel 110 from a fuel supply 112 into the encasement 102. The hydrocarbon fuel 110 may include diesel, kerosene, or the like. That is, any hydrocarbon fuel 110 can be used. The second intake 106 allows entry of a quantity of oxygen 114 into the encasement 102. It is contemplated that the oxygen 114 may be provided from ambient air 116. That is, it is contemplated that the second intake 106 allows entry of ambient air 116 having oxygen 114 therein into the encasement 102.

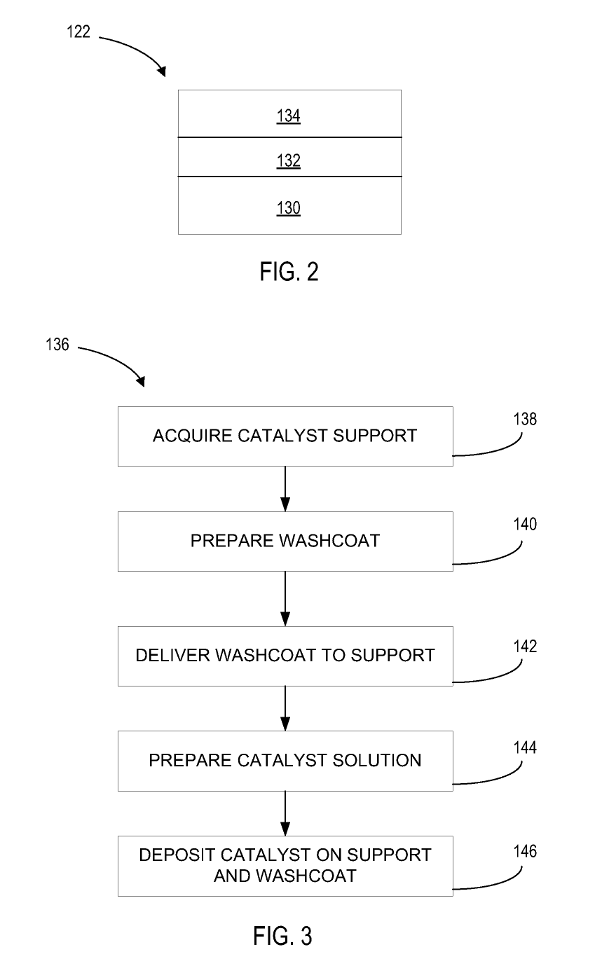

Within an interior volume 118 of the encasement 102, the hydrocarbon fuel 110 and the oxygen 114 form a mixture 120 that has a carbon to oxygen ratio that is greater than one to one. (i.e., C:O is greater 1:1). The carbon to oxygen ratio in the mixture 120 may range, for example, from a two-to-one ratio to a three-to-one ratio (i.e., 2:1 to 3:1). A catalyst unit 122 in the encasement 102 receives the mixture 120 and allows the mixture 120 to pass thereover or therethrough to catalyze an autothermal reaction that converts the mixture 120 into a plurality of reductants 124 such as secondary hydrocarbons. That is, the catalyst unit 122 catalyzes a reaction where heat needed for the reaction is produced in-situ (i.e., the reaction is autothermal). In one embodiment, the autothermal reaction is a catalytic partial oxidation reaction. The catalyst unit 122 will be described in greater detail below with respect to FIGS. 2 and 3.

Still referring to FIG. 1, it is contemplated that the plurality of reductants 124 includes a plurality of hydrocarbons reductants, each having a chain length less than a chain length of the hydrocarbons found in the hydrocarbon fuel 1 10. For example, the hydrocarbon reductants found in the plurality of reductants 124 may have a chain length in a range from C₂ to C₈ while the hydrocarbons found in the hydrocarbon fuel 110 have a chain length of C₁₆. The plurality of reductants 124 are then passed through the output 108.

In one embodiment, the plurality of reductants 124 are allowed to pass into a selective catalytic reduction (SCR) unit 126 where they are mixed with an exhaust stream 128. The SCR unit 126 then catalyzes a reaction with the plurality of reductants 124 and the exhaust stream 128 that reduces the quantity of NOₓ in the exhaust stream 128. As such, in such an embodiment, the plurality of reductants 124 produced by the fuel conversion unit 100 are used to aid in the reduction of NOₓ emissions from an engine or the like. NOₓ may include, for example, nitric oxides and nitrogen dioxides.

Referring to FIG. 2, a block diagram of cross-sectional view of a portion of catalytic unit 122 is shown according to an embodiment of the invention. As shown in the cross-sectional view, the catalyst unit 122 includes a catalyst support 130, a washcoat 132, and a catalyst 134. It is noted that the relative thicknesses of the catalyst support 130, the washcoat 132, and the catalyst 134 to each other may be exaggerated for illustrative purposes. In one embodiment, the catalyst 134 comprises at least one metal such as rhodium. However, as will be discussed in greater detail with respect to FIG. 3 below, it is also contemplated that the catalyst 134 may include other metals or combinations thereof that would be effective is catalyzing the autothermal reaction described above with respect to FIG. 1. Still referring to FIG. 2, the catalyst support 130 is chosen such that it has proper mechanical strength and acceptable pressure drop for its particular application.

Referring to FIG. 3, a technique 136 for assembling, creating, forming or manufacturing a catalytic unit, such as catalytic unit 122 of FIGS. 1 and 2, is shown according to an embodiment of the invention. Starting at BLOCK 138 of FIG. 3, a catalyst support is acquired. In one embodiment, a catalyst support having a ceramic substrate that comprises an alumina foam is chosen. For example, such a support may be an alpha alumina foam of 99.5% purity with a pore size that ranges from forty-five to sixty-five ppi. Other catalyst supports, however, are contemplated. After acquiring the catalyst support, a washcoat, which will later be delivered over the catalyst support, is prepared at BLOCK 140. In one embodiment, the washcoat includes a high surface area alumina powder with dopants of one or more of zirconia, yttria, and ceria having respective ratios as follows: Zr/AL₂O₃=0.003, Y/AL₂O₃=0.003, and Ce/AL₂O₃=0.001. Further, it is contemplated that the ratios are maintained by adding appropriate amounts of a nitrate precursor of Ce, Zr, and Y to a 40 μm alumina slurry or to a bohemite sol solution. In such an embodiment, a washcoat slurry is then prepared with a 15% Al₂O₃ content by mass. Using a solution of 0.5 HNO₃, the pH of the washcoat slurry or solution is adjusted to have a pH of approximately two. Washcoat preparation ends by ensuring that the washcoat is at room temperature.

After the washcoat is prepared 140, process control proceeds to BLOCK 142, where the prepared washcoat is delivered to the catalyst support. In one embodiment, where an alumina foam piece is used as the catalyst support, the washcoat solution is applied by hand dipping the alumina foam piece into the washcoat solution and then shaking any excess washcoat solution away. In an alternate embodiment using a sol-coated foam as a support, rather than shaking excess washcoat solution away, an air knife is used to push the solution out of sol-coated foam until the foam visually appears homogeneously coated. The catalyst support, whether an alumina or sol-coated foam support, is dried in a vacuum oven at 80° C. and 0.09 MPa between dips until a 5 wt % loading of the washcoat is applied. Such a procedure often results in a washcoat loading of 3 wt % after calcinations (±1%). Washcoated foams are calcined in air at a rate of 10° C./min. to 600° C. and held at 600° C. for 6 hours followed by cooling. Accordingly, the washcoat is adhered to the catalyst support.

As will be discussed below, in one embodiment, the catalyst is deposited to the washcoat and catalyst support using an incipient wetness impregnation technique that relies on a catalyst solution (i.e., a precursor with the one or more metals added thereto). By using a catalyst solution, the various overall weight loadings and metal ratios can be effectively managed. As such, the catalyst solution is prepared at BLOCK 144. In one embodiment, an appropriate nitrate solution (i.e., the precursor) is mixed, and the one or more metal catalysts are added thereto. The following Table 1 provides a non-exhaustive list of exemplary precursor solutions that may be used deliver and deposit the one or more catalyst metals to the washcoat and support.

TABLE 1
PRECURSORS

| Component | Precursor Specifications |
|---|---|
| Al2O3 | γ-Al2O3, 99.9% 40 μm |
| Bohemite sol | 80% bohemite solution in water |
| Rh | Rh(NO₃)₃ 10% w/w |
| Pt | H₂PtCl₆*6H₂O 99.95% |
| Ir | IrCl₄ 99.95% |
| La | La(NO₃)₃*6H₂O 99.9% |
| Zn | ZrO(NO₃)2*xH₂O 99.995% |
| Ce | Ce(NO₃)*6H₂O 99.5% |
| Sn | SnCl₂ 99% |
| Pd | Pd(NO₃)₂*xH₂O 99.9% |
| Re | HReO₄ 75% Aq. |
| Y | Y(NO₃)₃*xH₂O 99.99% |

After the catalyst solution is mixed, the solution is brought to the appropriate volume, which at least approximately matches the internal volume of the foam (i.e., the support such as catalyst support 130 of FIG. 2). In one embodiment, the total internal volume of the foam is determined by first determining the internal void fraction of the foam. An exemplary internal void fraction value of a catalyst support having a ppi value of forty-five is 0.62. An exemplary internal void fraction of a catalyst support having ppi of sixty-five is 0.63. The determined value is then used to estimate the total internal volume of the foam. After determining the total internal volume of the foam, the catalyst solution is expanded to substantially match the determined internal volume. In one embodiment, deionized water is added to the solution to increase the volume of the solution to the determined internal volume of the foam to be impregnated. It is contemplated that the volume of the solution can be increased to a volume slightly above the internal volume of the foam. The catalyst solution preparation step at BLOCK 144 may occur in a different order from that shown in FIG. 3 as long as the catalyst solution is prepared prior to its deposition.

After the catalyst solution is prepared 144, process control proceeds to BLOCK 146 of FIG. 3, where the catalyst and its accompanying precursor solution is deposited onto the support and washcoat (e.g., washcoat 132 of FIG. 2). As mentioned above, in one embodiment, an incipient wetness impregnation technique is used to deposit the catalyst on the washcoat and foam. In such an embodiment, approximately half of the catalyst solution is impregnated on one face of the foam, followed by drying at 80° C. with a pressure of 0.09 MPa in a vacuum furnace. The other half of the catalytic solution is then impregnated onto the other face of the foam and subsequently dried in the same manner as the first half. It is contemplated that some catalysts may be delivered with impregnations performed in multiples of 2 or more. For example, each side of the foam may need to be impregnated twice in order to deposit the appropriate quantities of the catalyst. Following the impregnation, the catalyst support, washcoat, and catalyst is then calcined at 600° C. for 6 hours with a 1° C./min. heating rate. Accordingly, the appropriate quantities of the one or more catalyst are deposited or adhered to the washcoat and catalyst support.

As discussed above, it is contemplated that a variety of metals and metal combinations can be used as a catalyst in a catalyst unit according to embodiments of the inventions. In addition to the variety of catalyst metals that may be used, it is also contemplated that a variety of catalyst supports and washcoats may be used in a manner consistent with embodiments of the present invention. Table 2, below, provides a non-exhaustive list of catalyst metals, as well as a non-exhaustive list of a variety of catalyst supports that may be used in a manner consistent with embodiments of the invention.

TABLE 2
CATALYST AND SUPPORT COMPOSITION

| Catalyst Formulation | Support Type |
|---|---|
| 0.30% Rh, 1% Zn, 0.1% Pt | Yttria-stabilized zirconia (65 ppi) |
| 2% Rh, 2% Ce | Alumina (65 ppi) |
| 0.3% Rh, 1% Zn, 0.1% Pt | Alumina (65 ppi) |
| 5% Rh | Alumina (65 ppi) |
| 0.5% Ir, 0.5% La, 0.2% Pt, 0.1% Rh | Alumina (65 ppi) |
| 0.5% Ir, 0.5% La, 0.2% Pt, 0.1% Rh | Yttria-stabilized zirconia (65 ppi) |
| 0.5% Ir, 0.5% La, 0.2% Pt, 0.1% Rh | Alumina (45 ppi) |
| 0.3% Pt, 1% Sn, 0.3% Rh | Alumina (65 ppi) |
| 0.5% Pt, 0.5% Ir, 0.5% Rh | Alumina (65 ppi) |
| 0.5% Rh, 0.5% Re | Alumina (65 ppi) |
| 0.1% Rh | Alumina (65 ppi) |

In addition to showing various catalysts including one or more metals along with various support components, Table 2 also lists exemplary percentages of catalyst metals relative to the overall mass of the catalyst, washcoat, and catalyst support combination that may be used in a manner consistent with embodiments of the invention.

The invention has been described in terms of the preferred embodiment, and it is recognized that equivalents, alternatives, and modifications, aside from those expressly stated, are possible and within the scope of the appending claims.

What is claimed is:

1. An apparatus for reducing fuel comprising:
an encasement having:
a first intake formed therein, the first intake configured to allow entry of a hydrocarbon fuel into the encasement; and
a second intake formed therein, the second intake configured to allow entry of oxygen into the encasement; and
a catalyst attached to the encasement and fluidly coupled to the first and second intakes, the catalyst configured to catalyze an autothermal reaction to convert a mixture into a plurality of reductants comprising a plurality hydrocarbons having a hydrocarbon chain length that is less than a hydrocarbon chain length of hydrocarbons in the hydrocarbon fuel, wherein the mixture comprises the hydrocarbon fuel and the oxygen, and wherein the mixture has a carbon-to-oxygen ratio that is greater than a one-to-one ratio.

2. The apparatus of claim 1 further comprising a selective catalytic reduction unit fluidly coupled to the catalyst, wherein the selective catalytic reduction unit is configured to:
receive the plurality of reductants;
receive an exhaust stream; and
catalyze a reaction with the plurality of reductants and the exhaust stream to reduce a quantity of one of nitric oxides and nitrogen dioxides in the exhaust stream.

3. The apparatus of claim 1 wherein the autothermal reaction is a catalytic partial oxidation reaction.

4. The apparatus of claim 1 wherein the catalyst comprises one of platinum and rhodium.

5. The apparatus of claim 1 wherein the hydrocarbon fuel is a diesel fuel.

6. The apparatus of claim 1 further comprising a catalyst support coupled to the catalyst.

7. The apparatus of claim 6 wherein the catalyst support comprises an alumina foam material.

8. The apparatus of claim 6 further comprising a washcoat coupled to the catalyst support and to the catalyst, wherein the washcoat comprises alumina powder.

9. The apparatus of claim 8 wherein the washcoat further comprises one of zirconia, yttria, and ceria.

10. A method comprising:
forming a plurality of transport paths configured to mix a quantity of air with a quantity of hydrocarbon fuel to form a mixture, wherein the quantity of air comprises oxygen, and wherein the mixture has a carbon-to-oxygen ratio that is greater than a one-to-one ratio; and
assembling a catalytic unit in fluid communication with the plurality of transport paths, wherein the catalytic unit is configured to catalyze an autothermal reaction that converts at least a portion of the mixture to a plurality of reductants, and wherein the plurality of reductants comprises hydrocarbon reductants having hydrocarbon chain lengths that are less than a hydrocarbon chain length of the hydrocarbon fuel.

11. The method of claim of claim 10 further comprising forming the catalytic unit, wherein forming the catalytic unit comprises:
adhering a washcoat to a catalyst support; and
adhering a catalyst to the washcoat.

12. The method of claim 10 wherein the autothermal reaction is a catalytic partial oxidation reaction, and wherein the hydrocarbon chain lengths of the hydrocarbon reductants lie in a range from C₂ to C₈.

13. The method of claim 12 further comprising regulating a rate at which the mixture converts to the hydrocarbon reductants.

14. A method comprising:
adhering a washcoat to a catalyst support; and
adhering a catalyst to the washcoat, wherein the catalyst is configured to catalyze an autothermal reaction to convert a mixture having a carbon-to-oxygen ratio greater than one-to-one into secondary hydrocarbons, and wherein the mixture comprises a hydrocarbon fuel and oxygen.

15. The method of claim 14 wherein the secondary hydrocarbons are chain hydrocarbons having a hydrocarbon chain length less than a hydrocarbon chain length of hydrocarbons the hydrocarbon fuel.

16. The method of claim 15 wherein the catalyst support comprises an alumina foam having pores formed therein at one of 45 ppi and 65 ppi.

17. The method of claim 14 wherein the catalyst comprises rhodium.

18. The method of claim 17 wherein the catalyst further comprises rhenium.

19. The method of claim 17 wherein the catalyst further comprises cerium.

20. The method of claim 17 wherein the catalyst further comprises platinum.

21. The method of claim 20 wherein the catalyst further comprises tin.

22. The method of claim 20 wherein the catalyst further comprises zinc.

23. The method of claim 20 wherein the catalyst further comprises iridium.

24. The method of claim 23 wherein the catalyst further comprises lanthanum.
